(19) United States
(12) Patent Application Publication
(10) Pub. No.: US 2002/0118463 A1
(43) Pub. Date: Aug. 29, 2002

(54) 3-port optical device

(75) Inventors: Li Wu, Fuzhou Fujian (CN); Haiyang Ning, Fuzhou Fujian (CN); Zengping Chen, Fuzhou Fujian (CN); Xueqin Huang, Fuzhou Fujian (CN)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA

(21) Appl. No.: 10/011,909

(22) Filed: Nov. 5, 2001

(30) Foreign Application Priority Data
Nov. 3, 2000 (CN) 00240874.0

(51) Int. Cl. G02B 27/12; G02B 6/26

(52) U.S. Cl. 359/639; 359/640; 385/47

(57) ABSTRACT

A thee port polarization beam splitter is disclosed which utilizes only two GRIN lenses. Two beams are split by a bireferingent crystal into two orthogonally linear polarized parallel sub-beams. The two parallel beams are redirected to converge to a single same location at an end face of the GRIN lens by a roof prism and are coupled by the same lens to two optical fibers held in a fiber tube physically coupled to the GRIN lens.

### FIELD OF THE INVENTION

This invention relates generally to a device for coupling an optical signal from at least one port to two other ports or from two spaced locations to two other spaced locations having a different spacing.

### BACKGROUND OF THE INVENTION

When coupling optical signals between optical waveguide ports it is desired to do so efficiently with low loss and at low cost. lit is therefore preferred to have a minimal number of components. One nearly ubiquitous component used in the coupling of optical signals to or from optical fibres is the graded index (GRIN) lens. These rod lenses have a refractive index that varies radially from the optical axis; conveniently GRIN lenses can be easily polished to a desired pitch for producing collimated or early collimated beams of light. Lenses of this type are produced under the trade name “SELFOC”; the mark is registered in Japan and owned by the Nippon Sheet and Glass Co. Ltd. GRIN lenses are used extensively as a means of coupling optical signals from one waveguide such as an optical fiber, to another, for example, in optical switches. GRIN lenses provide a number of advantages over other conventional lenses. They are relatively inexpensive, compact, and furthermore have parallel flat end faces ideal for coupling with other planar optical components. Light can be transmitted or received along the optical axis of a GRIN lens, or alternatively, light can be launched into a GRIN lens offset from its optical axis. In some instances numerous ports can be disposed spaced from the optical axis of a single GRIN lens.

At times, it is required to couple spaced apart unguided light signals with the cores of two or more optical fibres or waveguides spaced apart with a different fixed spacing; doing so with minimal losses is also desired.

For example, the task of coupling two spaced parallel beams spaced by a spacing d_{large} with to two optical fibres respectively, held within a fibre tube having very aclose spacing between the optical fibre cores can be daunting.

It is an object of this invention to provide an optical circuit having an inexpensive component disposed in an optimum location that will allow such a transformation to occur, thereby directing two widely spaced parallel beams to couple into two closely spaced parallel optical waveguides.

### SUMMARY OF THE INVENTION

In accordance with the invention, an arrangement of optical components is provided wherein two parallel widely spaced beams of light are coupled with two closely spaced ports such that a transformation occurs of two widely spaced parallel beams to two narrowly spaced parallel beams by launching the widely spaced parallel beams through a roof prism for directing the two widely spaced beams to two converging beams which cross one another as they pass through the optical axis of a GRIN lens disposed between the roof prism and the closely spaced ports.

In accordance with the invention, an arrangement of optical components is provided comprising;

two optical waveguides having their cores spaced at a fixed distance d;

a lens optically coupled with said two optical waveguides;

first means for providing two spaced beams spaced by a distance substantially greater than said fixed separation; and

second means optically coupled to said first means for directing said two spaced beams received by said first means to the lens, such that the two spaced beams converge at a point about an end face of the lens and cross one another as two diverging beams after said point and couple with said two optical waveguides respectively as focused beams.

In accordance with the invention there is provided, an optical circuit comprising:

a beam splitter for providing two orthogonally polarized at least substantially parallel beams of light;

a single lens for receiving the two orthogonally polarized beams of light;

a prism having substantially no optical power for bending the beams of light such that they both cross the optical axis of the lens when they are incident thereupon; and,

two waveguides optically coupled with the lens, each for receiving one of the beams of light as focused beams.

In accordance with the invention there is provided, an optical circuit comprising:

means for providing two at least substantially beams of light;

a single lens for receiving the two beams of light;

a prism having substantially no optical power for bending the beams of light such that they both cross the optical axis of the lens when they are incident thereupon; and,

two waveguides optically coupled with the lens, each for receiving one of the beams of light as focused beams.

In accordance with another aspect of the invention there is further provided a 3-port optical device comprising:

a first GRIN lens having two optical waveguides coupled thereto;

a second GRIN lens having a single waveguide coupled thereto;

means coupled to the second GRIN lens for separating light launched into the first waveguide into two sub-beams separated by a distance d₁;

a prism for changing the direction of the two sub-beams and directing the sub-beams such that they cross the optical axis of the first GRIN lens at a same location and coupled into two of the three ports respectively.

### BRIEF DESCRIPTION OF THE DRAWINGS

Exemplary embodiments of the invention will now be described in conjunction with the drawings in which:

FIG. 1 is prior art 3-port polarization beam splitter (PBS)/polarization beam combiner wherein each port has a separate lens for providing a focused beam to a respective adjacent optical fiber or for collimating light received from a respective adjacent optical fibre directly coupled therewith;

FIG. 2 is a polarization beam splitter in accordance with this invention wherein only two lenses are required to couple light between three optical ports;

FIG. 3 is an optical circuit in accordance with this invention wherein the PBS of FIG. 2 is housed within a housing having a single port at one end and dual ports at another end and wherein only a single GRIN lens is utilized at each end; and,

FIG. 4 is a detailed view of a GRIN lens having two optical fibres coupled to an end thereof, and which illustrates that two beams from or to the two lenses pass through the optical axis of the lens at a same location.

### DETAILED DESCRIPTION

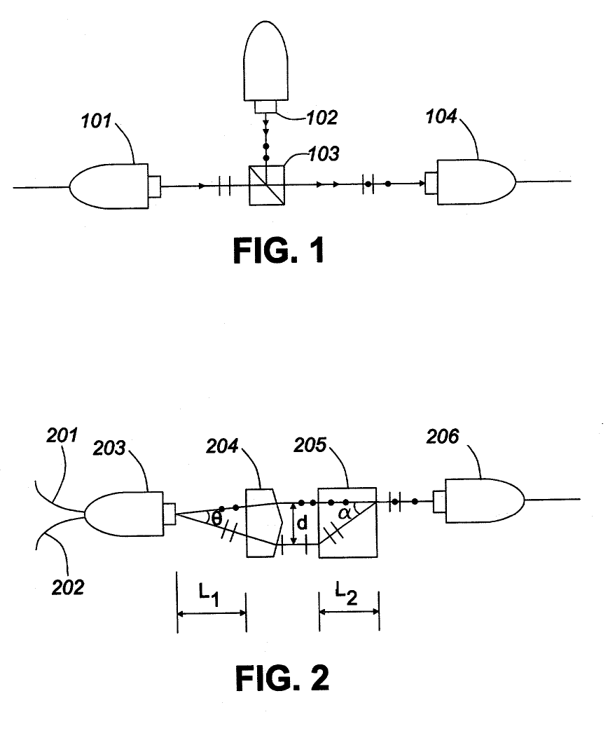

Turning now to FIG. 1, a prior art PBS is shown, being utilized as a polarization beam combiner. It should be understood that these devices can be used in one direction as beam combiners and in another reverse direction as polarization beam splitters. Linearly polarized light is launched into a port at an input/output end of 101 which consists of an optical fibre held in a sleeve directly coupled with a GRIN lens; the light is destined for port 104. Similarly linear polarized light having a polarization that is orthogonal to the light launched into 101 is launched into 102 consisting of a second optical fibre held in a sleeve directly coupled with a GRIN lens. The light incident upon beam combiner/splitter 103 combines the two orthogonally polarized beams and the resulting elliptically polarized beam is directed to port 104 which consists of a GRIN lens coupled to an optical fibre held in a sleeve. The purpose of each GRIN lenses directly coupled with a fibre is to collimate light received from the fibre or focus light destined for the fibre. In this figure the centres of the cores of the optical fibres are each directly coupled with the optical axis of the lens they are directly coupled with. Hence in each instance the lens is coaxial with its respective optical fibre.

FIG. 2 illustrates a similar circuit however only two GRIN lenses are required. In a beam combining mode of operation elliptically polarized light is launched into optical fibre and GRIN lens port 206. The light is collimated by the lens and is directed to a birefringent crystal 205, for example, rutile, calcite, or other material that will provide two parallel, orthogonally linear polarized sub-beams. The crystal 205 separates the light into two sub-beams that are parallel as the exit the crystal. A glass roof prism 204 receives the two beams and redirects these collimated sub-beams to a same location at an end face of the lens; the two sub-beams then cross each other at this location and are directed to the two optical fibres 203 held side-by-side in an optical fibre sleeve. Thus light propagating the lower half of the prism couples to fibre 201 and light propagating through the upper portion of the prism 204 is directed couple into fibre 202. In the exemplary embodiment shown, it is required to have two parallel beams converge to a single location at the end face of the lens, and a symmetrical roof prism is used, however in other instances if the beams are not completely parallel the prism may be of other geometry and may not be symmetrical roof prism. By way of example, if the beams are not completely parallel, a prism of different geometry that will direct both beams to cross the optical axis at a same location about the end face may be useful in directing the beams to two optical fibres spaced differently from the optical axis of the lens. Notwithstanding, using a symmetrical roof prism to direct two parallel beams to two fibres spaced a same distance from the optical axis of a GRIN lens has many practical and useful applications, since, often two fibers may be disposed in a common sleeve.

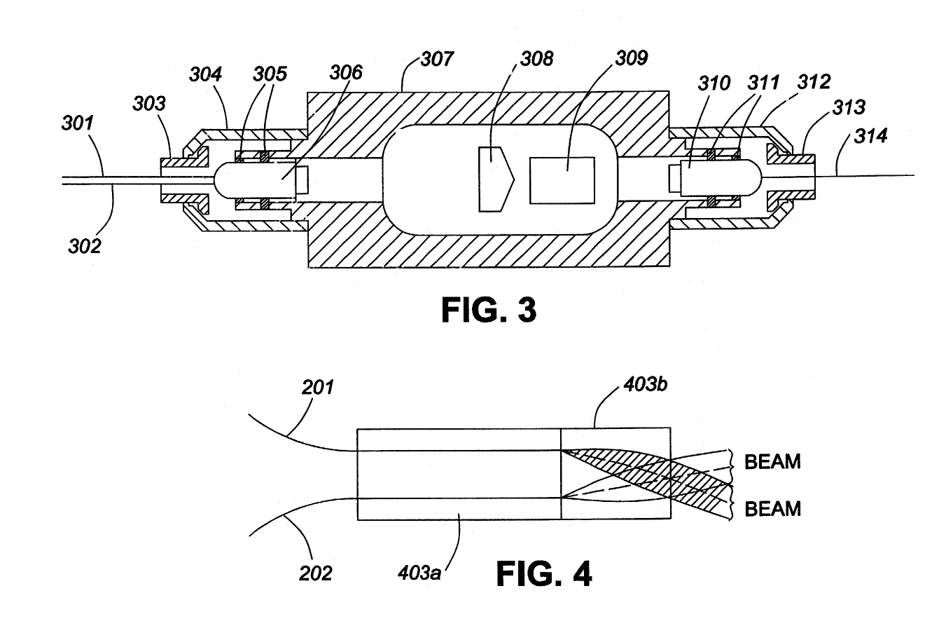

Turning now to FIG. 3 a mechanical structure is shown where the metal outside housing 307 forms a hermetic structure; Prism 308 crystal 309 are directly fixed in the housing; the collimator and the housing are connected using metal solder. The crystal 310 can be YVO₄, rutile, or any birefringent crystal. 301 and 302 are polarization maintaining optical fibres; Protective rubber sleeves 303 and 313 are shown and a stainless steel housing 304 and 312 are provided; 305 and 311 are solder. Element 306 is a double fibre collimator which includes a fibre sleeve and a GRIN lens; The right angle prism 308 and birefringent crystal 309 are shown disposed within the cavity of the housing 307; A single fibre collimator 310 is shown having a single optical fibre 314 housed within a fibre sleeve.

The mechanism through which light couples to two adjacent closely spaced cores of two optical fibres 202 and 201 is shown in more detail by viewing FIG. 4. Instead of light propagating along the optical axis of the GRIN lens, light is coupled to ports, optical fibres 201 and 202 that are offset a same distance from the optical axis of the GRIN lens 403b. The optical fibres 202 and 201 are offset from the optical axis within sleeve 403a coupled to the GRIN lens 403b.

Of course numerous other embodiments may be envisaged, without departing from the spirit and scope of the invention.

What is claimed is:

1. An optical circuit comprising:
means for providing two parallel beams of light;
a single lens for receiving the beams of light;
a prism having substantially no optical power for bending the beams of light such that they converge, and such that centers of both of the beams cross the optical axis of the lens substantially at a same location; and,
two waveguides optically coupled with the lens, each for receiving one of the beams of light as focused beams.

2. An optical circuit as defined in claim 1 wherein both of the beams cross the optical axis of the lens at an end face of the lens.

3. An optical circuit as defined in claim 1 wherein the means for providing at least two substantially parallel beams of light is a beam splitter/combiner having a single port at one end, and two ports for providing substantially parallel orthogonal linearly polarized output beams.

4. An optical circuit as defined in claim 3 wherein the prism is a roof prism optically coupled to receive the linearly polarized output beams or to provide to orthogonally polarized output beams to the beam splitter/combiner for combining.

5. An optical circuit as defined in claim 1 wherein the means for providing the two beams of light is for providing at least two substantially parallel beams of light.

6. An optical circuit as defined in claim 1 wherein the single lens is a GRIN lens, and further comprising a second GRIN lens for providing a single beam of light to the means for providing means for providing the two beams of light;

7. An optical circuit as defined in claim 1 wherein the prism is a roof prism.

8. An optical circuit comprising:
a beam splitter for providing two orthogonally polarized at least substantially parallel beams of light;
a single lens for receiving the two orthogonally polarized beams of light;
a prism having substantially no optical power for bending the beams of light such that they both of the beams cross the optical axis of the lens at a same location; and,
two waveguides optically coupled with the lens, each for receiving one of the beams of light as focused beams.

9. An optical circuit as defined in claim 1 wherein both of the beams cross the optical axis of the lens at an end face of the lens.

10. An optical circuit as defined in claim 8 wherein the beam splitter is a birefringent crystal.

11. An optical circuit as defined in claim 10 further comprising a second lens for providing a substantially collimated beam to the beam splitter.

12. An optical circuit comprising;
two optical waveguides having their cores spaced at a fixed distance d;
a lens optically coupled with said two optical waveguides;
first means for providing two spaced beams spaced by a distance substantially greater than said fixed separation; and
second means optically coupled to said first means for directing said two spaced beams received by said first means to the lens, such that the two spaced beams converge at a point about an end face of the lens and cross one another as two diverging beams after said point and couple with said two optical waveguides respectively as focused beams.

13. A 3-port optical device comprising:
a first GRIN lens having two optical waveguides coupled thereto;
a second GRIN lens having a single waveguide coupled thereto;
means coupled to the second GRIN lens for separating light launched into the first waveguide into two sub-beams separated by a distance d₁;
a prism for changing the direction of the two sub-beams and directing the sub-beams such that they cross the optical axis of the first GRIN lens at a same location and coupled into two of the three ports respectively.

14. An optical device as defined in claim 13 wherein the GRIN lenses are collimating lenses.

15. A method of coupling two parallel beams spaced by a distance d, to two optical fibres spaced a different smaller distance d₂, comprising the steps of:
directing the two parallel beams spaced by d, to a prism that will direct the two beams to coverage at a same location;
ensuring that the two beams enter a lens having an optical axis such that the optical axis is disposed at said same location; and,
allowing the two sub-beams to focus into two optical fibres respectively, after passing through the lens.
